(19) United States
(12) Patent Application Publication
(10) Pub. No.: US 2015/0237878 A1
(43) Pub. Date: Aug. 27, 2015

(54) MULTI-PACKET SYSTEM FOR THICKENED BEVERAGES

(71) Applicant: NESTEC S.A., Vevey (CH)

(72) Inventors: Winardi Kusumaatmaja, Saint Paul, MN (US); Carsten Cramer, Grosshochstetten (CH); Carla Delannoy, Edina, MN (US)

(21) Appl. No.: 14/436,541

(22) PCT Filed: Oct. 18, 2013
(86) PCT No.: PCT/EP13/71808

§ 371 Date: Apr. 17, 2015

Related U.S. Application Data
(60) Provisional application No. 61/715,491, filed on Oct. 18, 2012.

(51) Int. Cl. A23C 9/154; A23L 2/52; A23L 2/39; A23L 2/385

(52) U.S. Cl. CPC A23C 9/1542; A23L 2/385; A23L 2/52; A23L 2/39; A23V 2002/00

(57) ABSTRACT

Thickened milk and fruit containing beverages and components thereof are provided. In a general embodiment, the present disclosure provides a shelf-stable beverage component product including a dry components packet and a wet components packet. The dry components packet includes milk powder. The wet components packet includes a fruit component and a carrageenan component. The wet components packet is at least in a partially liquid state. The dry components packet and the wet components packet are combined together in a liquid carrier to provide a thickened beverage.

### BACKGROUND

The present disclosure generally relates to beverages. More specifically, the present disclosure is directed to thickened milk and fruit containing beverages.

There are many types of beverages currently on the market. The beverages can be targeted toward certain consumer types, for example, young, elderly, athletic, etc., based on the specific ingredients of the beverage. The beverages can also be formulated based on the certain physiological conditions that the beverages are intended to treat or improve, or may be based on desired physical or organoleptic properties of the beverages.

Such beverages may be provided in many forms. One form is a thickened liquid beverage. Thickened beverages are beverages with a consistency thicker than that of water. Many people enjoy the physical and organoleptic properties of thickened liquid beverages such as smoothies or milkshakes. Proteins, such as those contained in milk or milk products, are essential for the normal growth and development of humans. However, the addition of proteins and stabilizers to thickened liquid beverages can sometimes lead to physico-chemical shelf-instability issues such as sedimentation, syneresis, age gelation and phase separation. Therefore, some beverages are provided in powder form, which is then mixed with a liquid carrier to make a thickened beverage. These powdered beverages often require long wait times and much stiffing, which sometimes requires the use of blenders or other blending technologies, to accomplish the desired organoleptically-pleasing thickness.

### SUMMARY

The present disclosure generally relates to a system for providing thickened beverages, and more specifically to providing thickened beverages which contain fruit and milk. The system overcomes problems with powder-based thickened beverages which often require long wait times and much stiffing to accomplish the desired organoleptically-pleasing thickness. Further, to properly blend the beverages, blending devices may need to be used, which can present a whole host of inconveniences such as blender set up, cleaning, disassembly after use, safety issues with children, etc.

In an embodiment, the present disclosure provides a shelf-stable beverage component product including a dry components packet and a wet components packet. The dry components packet includes milk powder. The wet components packet includes a fruit component and a carrageenan component. The wet components packet is at least in a partially liquid state. When the dry components packet and the wet components packet are combined together in a liquid carrier they provide a thickened beverage.

In an embodiment, the liquid carrier is selected from the group consisting of water, milk, or combinations thereof.

In an embodiment, the carrageenan component is selected from the group consisting of lambda carrageenan, iota carrageenan, kappa carrageenan, or combinations thereof.

In an embodiment, the dry components packet also includes a hydrocolloid component. In a further embodiment, the hydrocolloid component is selected from the group consisting of carrageenan, agar-agar, gelatin, pectin, xanthan gum, gum arabic, guar gum, locust bean gum, cellulose derivatives, alginate, starch, or combinations thereof.

In an embodiment, the wet components packet also includes a hydrocolloid component. In a further embodiment, the hydrocolloid component is selected from the group consisting of carrageenan, agar-agar, gelatin, pectin, xanthan gum, gum arabic, guar gum, locust bean gum, cellulose derivatives, alginate, starch, or combinations thereof.

In an embodiment, the wet components packet has an acidic pH.

In an embodiment, the combined dry components packet and wet components packet in the liquid carrier has a neutral pH.

In another embodiment, the combined dry components packet and wet components packet in the liquid carrier has pH greater than the isoelectric point of casein, or greater than 4.6.

In an embodiment, the combined dry components packet and wet components packet in the liquid carrier reaches a desired thickness threshold within about one minute without a blender (e.g., using a spoon). In a further embodiment, the desired thickness threshold is that of a smoothie or that of a milkshake.

In an embodiment, the fruit component is selected from the group consisting of fruit juice, fruit juice concentrate, fruit puree, fruit pulp, fruit pieces, or combinations thereof. The fruit component may be artificial or dried as well.

In another embodiment, the present disclosure provides a system for making a thickened beverage including a dry components packet and a wet components packet. The dry components packet includes milk powder. The wet components packet includes a fruit component and a carrageenan component that are at least in a partially liquid state. When the dry components packet and the wet components packet are combined together in a liquid carrier they provide a thickened beverage in less than about one minute without a blender.

In an embodiment, the milk powder is present in an amount from about 1% to about 10%, or from about 2% to about 9%, or from about 3% to about 8%, or from about 4% to about 7%, or from about 5% to about 6% by weight of the combined dry components packet and wet components packet in the liquid carrier. The % weights herein are based on the total weight of the combined, thickened beverage unless specified otherwise.

In an embodiment, the fruit component is present in an amount from about 2% to about 30%, or from about 4% to about 26%, or from about 6% to about 22%, or from about 8% to about 18%, or from about 10% to about 14%, or about 12% by weight of the combined dry components packet and wet components packet in the liquid carrier. In an embodiment, the fruit component is present in an amount from about 5% to about 27% by weight of the combined dry components packet and wet components packet in the liquid carrier.

In an embodiment, the carrageenan component is present in an amount from about 0.045% to about 0.125% by weight of the combined dry components packet and wet components packet in the liquid carrier.

In an embodiment, the liquid carrier is present in an amount from about 65% to about 85% by weight of the combined dry components packet and wet components packet in the liquid carrier.

In a further embodiment, the present disclosure provides a method for making a quickly-thickened milk and fruit containing beverage. The method includes combining a dry components packet comprising milk powder and a wet components packet comprising a fruit component and a carrageenan component with a liquid carrier without using a blender.

In another embodiment, the present disclosure provides a shelf-stable thickened beverage component including a packet. The packet includes a fruit component and a carrageenan component. The packet is at least in a partially liquid state.

An advantage of the present disclosure to provide an improved shelf stable beverage component product.

Another advantage of the present disclosure is to provide an improved system for making a thickened beverage.

Still another advantage of the present disclosure is to provide a system for making a thickened beverage which causes the beverage to thickened in less than about one minute without the use of a blender.

Still another advantage of the present disclosure is to provide system for making a thickened beverage which includes milk and fruit.

Additional features and advantages are described herein, and will be apparent from the following Detailed Description.

### DETAILED DESCRIPTION

The present disclosure relates to components to make thickened beverages containing milk and fruit. The components can be shelf-stable. The beverage can be thickened by the use of a unique thickening system containing a specific configuration of dry and wet components along with carrageenan. The thickened beverages can be thickened quickly (e.g. in less than about one minute) without the use of a blender.

Prior art beverage component products and thickening systems generally include thickeners in a dry (unhydrated) form. Dry milk powder is also sometimes included. These dry components are then mixed with a liquid carrier. However, because the thickeners are unhydrated, they must first become hydrated before they can begin to thicken the beverage. The hydration and subsequent thickening effect can take several minutes or more, and may require a great amount of stiffing or even the use of a blender. Thus, many consumers find the lengthy wait and personal effort required to use such products inconvenient and frustrating.

Applicants have surprisingly found a unique combination of components for a thickening system that can quickly provide thickened milk and fruit containing beverages with a desired thickness (such as that of a smoothie or a milkshake) while also providing good mouthfeel. Specifically, the thickening system improves the rate of thickening by combining a carrageenan component with a fruit component which is at least in a partially liquid state. When the carrageenan and fruit are mixed with milk or milk powder, the already hydrated carrageenan is able to quickly build a network with the milk proteins to thicken the beverage.

In an embodiment, the present disclosure provides a shelf stable beverage component product including a dry components packet and a wet components packet. It should be appreciated that any number of packets may be used to subdivide the various desired components of the resultant beverage before they are combined in a liquid carrier. The packets are then combined with the liquid carrier to provide a thickened beverage.

In an embodiment, the dry components packet includes a dry dairy-based protein. The dairy-based proteins may be selected from the group consisting of casein, casein hydrolysates, caseinates, whey, whey hydrolysates, milk protein concentrate, milk protein isolate, or combinations thereof. The skilled artisan will appreciate that the present disclosure is not restricted to dairy-based proteins from bovine origin, but pertains to dairy-based proteins from all mammalian animal species, such as from sheep, goats, horses, and camels.

Health benefits provided by proteins include enhancement of muscle development and building, as well as muscle maintenance in children, adults or elderly people, enhancement of the immune function, improvement of cognitive function, control of blood glucose such that they are suitable for diabetics, weight management and satiety, anti-inflammatory effects, wound healing and skin repair, lowering of the blood pressure, etc.

Protein may also be used to mask the poor flavor profile of beneficial branched chain amino acids such as leucine, isoleucine and valine. In this manner, the milk protein-containing beverage of the present disclosure may provide functional nutrients to an individual while also being desirable for consumption by the individual.

In an embodiment, the wet components packet includes a fruit component and a carrageenan component. The fruit component may be fruit juice, fruit juice concentrate, fruit puree, fruit pulp, fruit pieces, or combinations thereof. The fruit component may be at least in a partially liquid state. It should be appreciated that any fruits (such as apples, strawberries, raspberries, and blueberries) or combination of fruits may be utilized.

The wet components packet includes a carrageenan component. The carrageenan component may be lambda carrageenan, iota carrageenan, kappa carrageenan, or combinations thereof. It is known that hydrocolloids such as carrageenans use hydrogen bonding to hold water around their base molecules. The water-binding property makes hydrocolloids good thickening agents which increase viscosity and assist in preventing syneresis. It is also known that carrageenans, which are hydrocolloids extracted from certain seaweeds, have a high protein reactivity, especially at neutral pH values. Specifically, carrageenans are known to react well with dairy proteins such as milk. For example, kappa carrageenan reacts well with casein micelles to form a loose three-dimensional gel network which assists in keeping insoluble particles suspended.

The use of carrageenans for milk-type products, especially chocolate milk type products, is known. However, carrageenans are not generally used with fruit juices, fruit juice concentrates, fruit purees, fruit pulp, or fruit pieces because carrageenans are not effective at thickening such substances, and will exhibit only minimal thickening. Carrageenans are not effective with fruit substances because such substances generally have a low, or acidic, pH, and because there are no proteins (or, in particular, dairy proteins) which the carrageenans can use to build a network. Instead, hydrocolloids such as pectin are typically used to thicken fruit-containing substances.

It has surprisingly been found that the addition of carrageenans to a fruit component that is at least in a partially liquid state improves the rate of thickening of a resultant beverage created by mixing the fruit and carrageenan with dry ingredients and with a liquid carrier. Specifically, the mixture of the fruit component with the carrageenans allows the carrageenans to exist in a hydrated state, with already-bonded water molecules. Yet, because the fruit component lacks dairy proteins and is at an acidic pH, the carrageenans impart minimal thickening effect to the fruit component.

When mixed with dry components and a liquid carrier at a more neutral pH, the already-hydrated carrageenans are able to quickly build a network with any dairy proteins in the dry components or liquid carrier. In this way, the consumer of the thickened beverage is not required to utilize a blender or otherwise expend a great deal of energy stirring the beverage in order to hydrate any thickening components. The consumer will also have a shorter wait time for an appropriately thickened beverage because they will not have to wait for the thickening components to become hydrated before they can begin to thicken the beverage. Additionally, an unthickened or minimally thickened set of wet components may be preferred because it will be easier to mix with dry components and/or a liquid carrier than a thickened component would be.

The liquid carrier may be milk (of any desired fat content), water, any other suitable liquid carrier, and combinations thereof. The liquid carrier may be present in an amount from about 5% to about 95%, about 15% to about 85%, about 25% to about 75%, about 5% to about 60%, about 30% to about 75%, about 60% to about 95%, or about 72% to about 78%. In one embodiment, the liquid carrier is present in an amount from about 70% to about 80%.

The dry components packet may include dry, powdered milk, such as non-fat dry milk, low heat. The dry milk may be present in an amount ranging from about 0.25% to about 30%, about 0.75% to about 20%, about 1% to about 15%, about 1.5% to about 10%, or about 3% to about 5% by weight of the beverage. In one embodiment, dry milk is present in an amount from about 2% to about 6% by weight of the resultant liquid beverage.

In an embodiment, the dry components packet further includes a hydrocolloid component. The hydrocolloid component can be selected to achieve a different thickness and/or mouthfeel. The hydrocolloid component can include any suitable hydrocolloid, such as, for example, carrageenans (kappa, iota and lambda), agar-agar, gelatin, pectin, xanthan gum, gum arabic, guar gum, locust bean gum, cellulose derivatives as carboxymethyl cellulose and microcrystalline cellulose, alginate, starch, or combinations thereof.

In another embodiment, the wet components packet may include a hydrocolloid component in addition to, or instead of, the dry components package. The hydrocolloid component can be selected to achieve a different thickness and/or mouthfeel. The hydrocolloid component can include any suitable hydrocolloid, such as, for example, carrageenans (kappa, iota and lambda), agar-agar, gelatin, pectin, xanthan gum, gum arabic, guar gum, locust bean gum, cellulose derivatives as carboxymethyl cellulose and microcrystalline cellulose, alginate, starch, or combinations thereof.

The dry components packet may also include various flavors, sweeteners, colorants, vitamins, minerals, amino acids, fiber or a source thereof, probiotics, antioxidants, or combinations thereof, as described below.

The wet components packet includes a fruit component which is at least partially in a liquid state. The fruit component may include any suitable or desired fruit, or combination of fruits.

The fruit component may be selected from the group consisting of fruit juice, fruit juice concentrate, fruit puree, fruit pulp, fruit pieces, or combinations thereof. For example, fruit puree (of one or more kinds of fruits) may be present in an amount from about 1% to about 70%, about 3% to about 50%, about 5% to about 25%, or about 12% to about 18% by weight of the beverage. In an embodiment, fruit puree is present in an amount from about 7% to about 27% by weight of the beverage.

The wet components packet includes a carrageenan component. The carrageenan component can be kappa carrageenan, lambda carrageenan, iota carrageenan, or combinations thereof. Varying thickness thresholds can be achieved by adjusting the concentration of the carrageenan component. Depending on the desired thickness, the carrageenan component may be present in an amount from about 0.001% to about 0.5%, about 0.01% to about 0.3%, about 0.045% to about 0.1%, about 0.05% to about 0.06%, or about 0.09% to about 0.11% by weight of the beverage. In one embodiment, the carrageenan component is present in an amount from about 0.075% to about 0.125% by weight of the beverage.

The wet components packet may also include various flavors, sweeteners, colorants, vitamins, minerals, amino acids, fiber or a source thereof, probiotics, antioxidants, or combinations thereof, as described below.

As discussed above, the use of a carrageenan component with proteins, especially milk proteins, is an effective thickener which helps to achieve a good mouthfeel and consistency in a resultant thickened beverage. The addition of the carrageenan component to a packet containing a fruit component which is at least partially in a liquid state has surprisingly been found, when mixed with dry components in a liquid carrier, to improve the rapidity of thickening the resultant beverage. Because the carrageenan component has little thickening effect on the fruit component, the wet components packet is easy to mix with other packets and/or a liquid carrier, and is able to quickly begin thickening a resultant beverage because the carrageenans are already hydrated.

Thus, the resultant beverage can be quickly thickened without the use of a blender. The resultant beverage includes milk and fruit, and is made by combining in a liquid carrier at least one packet of dry ingredients including milk powder, with at least one packet of wet or hydrated components which is at least partially in a liquid state and includes a fruit component. Additionally, the unique thickened beverage components system improves the body and texture of the beverage and provides a better mouthfeel.

Either, both, or all of the packets may also include one or more ingredients such as flavors, sweeteners, colorants, or combinations thereof. Sweeteners can include, for example, sucrose, sucralose, acesulfame K, fructose, dextrose, maltose, dextrin, maltodextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the beverage, the level and type of flavor used, and cost considerations. Any suitable combinations of sugar and/or sugarless sweeteners may be used in the packets.

Non-limiting examples of suitable flavors include chocolate, chocolate enhancers, cream/dairy enhancers, vanilla flavors, fruit flavors, mint flavors, spice flavors, or combinations thereof. The packets may also include malt or malt extract.

Either, both, or all of the packets may further include one or more vitamins and/or minerals. The vitamins include, but are not limited to, vitamin A, vitamin B₁ (thiamine), vitamin B₂ (riboflavin), vitamin B₃ (niacin or niacinamide), vitamin B₅ (pantothenic acid), vitamin B₆ (pyridoxine, pyridoxal, or pyridoxamine, or pyridoxine hydrochloride), vitamin B₇ (biotin), vitamin B₉ (folic acid), and vitamin B₁₂ (various cobalamins; commonly cyanocobalamin in vitamin supplements), vitamin C, vitamin D, vitamin E, vitamin K, folic acid, biotin, choline, or combinations thereof.

Non-limiting examples of the minerals include calcium, magnesium, iron or a combination thereof. The source of calcium can include calcium carbonate, calcium phosphate, calcium citrate, other insoluble calcium compounds or a combination thereof. The source of magnesium can include magnesium phosphate, magnesium carbonate, magnesium hydroxide or combination of thereof. The source of iron can include iron ammonium phosphate, ferric pyrophosphate, ferric phosphate, ferrous phosphate, other insoluble iron compounds, aminoacids, iron chelating compounds such as EDTA, or combinations thereof. The minerals may also include any of boron, calcium, chromium, copper, iodine, iron, magnesium, manganese, molybdenum, nickel, phosphorus, potassium, selenium, silicon, tin, vanadium, zinc, or combinations thereof.

Either, both, or all of the packets may further include an amino acid selected from the group consisting of alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

Either, both, or all of the packets may further include fiber or a source of fiber. The fiber may be a prebiotic selected from the group consisting of acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, their hydrolysates, or combinations thereof.

Either, both, or all of the packets may also include a probiotic selected from the group consisting of probiotics including Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

Either, both, or all of the packets may also include an antioxidant selected from the group consisting of carotenoids, coenzyme Q10 (“CoQ10”), sodium citrate dehydrate, flavonoids, glutathione Goji (wolfberry), hesperidine, lactowolfberry, lignan, lutein, lycopene, polyphenols, selenium, vitamin A, vitamin B₁, vitamin B₆, vitamin B₁₂, vitamin C, vitamin D, vitamin E, or combinations thereof.

### EXAMPLES

By way of example and not limitation, the following example is illustrative of an embodiment of the present disclosure.

### Example 1

A beverage was made including the ingredients specified below in Table 1. The ingredients were included within the specified ranges.

TABLE 1
Range of Ingredients for Quick Thickening

| | |
|---|---|
| | Range of % by weight |
| Ingredient | of total beverage |

Liquid Carrier

| | |
|---|---|
| Skim Milk | 70 to 80% |

Dry Components Packet

| | |
|---|---|
| Dry Milk | 2 to 6% |
| Various Vitamins, Minerals, Sweeteners, | 1.5% to 5.5% |
| Thickeners, Flavoring Agents, Colorants, etc. | |

Wet Components Packet

| | |
|---|---|
| Various Fruit Purees | 5 to 25% |
| Carrageenan Component | 0.045 to 0.095% |

The resultant thickened beverage was prepared by mixing together the dry components packet and the wet components packet in the liquid carrier. It was found that the resultant thickened beverage quickly achieved a smoothie consistency, which is thicker than milk, but thinner than a milkshake. The resultant thickened beverage was also found to have no residue, have a good appearance, mouth-feel, and a good flavor.

### Example 2

A beverage was made including the ingredients specified below in Table 2. The ingredients were included within the specified ranges.

TABLE 2
Range of Ingredients for Quick Thickening

| | |
|---|---|
| | Range of % by weight |
| Ingredient | of total beverage |

Liquid Carrier

| | |
|---|---|
| 2% Milk | 70 to 80% |

Dry Components Packet

| | |
|---|---|
| Dry Milk | 2.5 to 6.5% |
| Various Vitamins, Minerals, Sweeteners, | 2 to 6% |
| Thickeners, Flavoring Agents, etc. | |

Wet Components Packet

| | |
|---|---|
| Various Fruit Purees | 7 to 27% |
| Carrageenan Component | 0.075 to 0.125% |

The resultant thickened beverage was prepared by mixing together the dry components packet and the wet components packet in the liquid carrier. It was found that the resultant thickened beverage quickly achieved a thick, gelatinous, and milky consistency, which is similar to that of a milkshake. The resultant thickened beverage was also found to have a good appearance, mouth-feel, and a good flavor.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A shelf-stable beverage component product comprising:
a dry components packet, comprising milk powder;
a wet components packet, comprising a fruit component and a carrageenan component that are at least in a partially liquid state; and
the dry components packet and the wet components packet are so constructed and arranged that when they are combined together in a liquid carrier they provide a thickened beverage.

2. The shelf-stable beverage component product of claim 1, wherein the liquid carrier is selected from the group consisting of water, milk, and combinations thereof.

3. The shelf-stable beverage component product of claim 1, wherein the carrageenan component is selected from the group consisting of lambda carrageenan, iota carrageenan, kappa carrageenan, and combinations thereof.

4. The shelf-stable beverage component product of claim 1, wherein a hydrocolloid component is included in a packet selected from the group consisting of the dry components packet, the wet components packet, and combinations thereof.

5. The shelf-stable beverage component product of claim 4, wherein the hydrocolloid component is selected from the group consisting of carrageenan, agar-agar, gelatin, pectin, xanthan gum, gum arabic, guar gum, locust bean gum, cellulose derivatives, alginate, starch, and combinations thereof.

6. The shelf-stable beverage component product of claim 1, wherein the wet components packet has an acidic pH.

7. The shelf-stable beverage component product of claim 1, wherein the combined dry components packet and wet components packet in the liquid carrier has a pH above an isoelectric point of casein.

8. The shelf-stable beverage component product of claim 1, wherein the combined dry components packet and wet components packet in the liquid carrier reaches a desired thickness threshold within about one minute without a blender.

9. The shelf-stable beverage component product of claim 8, wherein the desired thickness threshold is that of a smoothie.

10. The shelf-stable beverage component product of claim 1, wherein the fruit component is selected from the group consisting of fruit juice, fruit juice concentrate, fruit puree, fruit pulp, fruit pieces, and combinations thereof.

11. A system for making a thickened beverage comprising:
a dry components packet comprising milk powder;
a wet components packet comprising a fruit component and a carrageenan component that are at least in a partially liquid state; and
the dry components packet and the wet components packet are so constructed and arranged that when combined together in a liquid carrier they provide a thickened beverage in less than about one minute without a blender.

12. The system of claim 11, wherein the milk powder is present in an amount from about 2% to about 7% by weight of the combined dry components packet and wet components packet in the liquid carrier.

13. The system of claim 11, wherein the fruit component is present in an amount from about 5% to about 27% by weight of the combined dry components packet and wet components packet in the liquid carrier.

14. The system of claim 11, wherein the carrageenan component is present in an amount from about 0.045% to about 0.125% by weight of the combined dry components packet and wet components packet in the liquid carrier.

15. The system of claim 11, wherein the liquid carrier is present in an amount from about 65% to about 85% by weight of the combined dry components packet and wet components packet in the liquid carrier.

16. A method for making a beverage, the method comprising:
combining a dry components packet comprising milk powder and a wet components packet comprising a fruit component and a carrageenan component with a liquid carrier without using a blender.

17. The method of claim 16, wherein when the dry components packet and the wet components packet are combined together with a liquid carrier without using a blender, the beverage reaches a desired thickness threshold in less than about one minute.

18. The method of claim 16, wherein the desired thickness threshold is that of a smoothie.

19. The method of claim 16, wherein the carrageenan component is present in an amount from about 0.045% to about 0.125% by weight of the beverage.

20. A shelf-stable beverage component comprising:
a packet comprising a fruit component and a carrageenan component, wherein the packet is at least in a partially liquid state.
